(19) United States
(12) Patent Application Publication
(10) Pub. No.: US 2026/0010840 A1
(43) Pub. Date: Jan. 8, 2026

(54) CONSTRAINT PROGRAMMING BASED SOLUTION FOR MULTIDIMENSIONAL VECTOR PACKING WITH HETEROGENEOUS BINS

(71) Applicant: Oracle International Corporation, Redwood Shores, CA (US)

(72) Inventors: Michael P. Colena, Hollis, NH (US); Gao Chen, Malden, MA (US); Joshua Griffin, Moon Township, PA (US)

(73) Assignee: Oracle International Corporation, Redwood Shores, CA (US)

(21) Appl. No.: 18/764,884

(22) Filed: Jul. 5, 2024

(51) Int. Cl. G06Q 10/04; G06Q 10/0631

(52) U.S. Cl. CPC G06Q 10/04; G06Q 10/06315

(57) ABSTRACT

A warehouse management system uses a constraint programming model and associated search algorithm for determining packing of items into minimal or otherwise moderated sets of heterogeneous bins (e.g., cartons or other types of containers). In some embodiments, a constraint solver of the warehouse management system minimizes or otherwise moderates the number of shipping containers required to package and ship a group of items. Packaging configurations may be based on multi-dimensional considerations of item properties, bin capacities, such as weight and volume capacities, ordering and grouping rules, and packaging restrictions. Given a set of items, each with a given weight and volume, and a set of containers, each with a specified weight and volume capacity, the goal is to compute carton placement for each item. Container selection may be performed such that the overall number of cartons required for packaging is minimized or otherwise moderated. Optionally, containers chosen for each group of packaged items may be chosen to minimize or otherwise moderate wasted space, while respecting item ordering and grouping.

### BACKGROUND

Cartonization falls into a family of classical optimization problems known as bin-packing problems, in which a set items must be packed into containers. While a number of specialized algorithmic approaches have been explored for packing, classical solutions typically reason over single dimensions and bins of uniform size without time and resource constraints. Real-world instances of packing may involve more complex packing considerations, time and resource constraints, and high volumes that prompt user involvement, inefficient outcomes, and re-packing mistakes.

On-time and accurate shipments are key to having the perfect order experience which today's customers expect. Efficient picking and packing of products for shipment is the most time critical part of a facility's operations. Inefficient outcomes, re-packing mistakes, and heavy user involvement can impair the order experience.

In order to address packing mistakes, companies hire more factory workers to work together in pursuit of more efficient solutions. The factory workers do not have clear visibility into the streaming pipeline of items to be packed, and the factory workers are unable to accurately and efficiently predict which items will fit into which containers and which items if, when placed together, will break during shipping. Such a lack of visibility into the item pipeline and downstream shipping outcomes leaves the factory workers unable to further improve the order experience. Companies are left with smaller margins due to a larger workforce and unhappy customers due to broken or lost items, damaged or destroyed boxes, and wasted shipping materials.

### BRIEF SUMMARY

A warehouse management system uses a constraint programming model and associated search algorithm for determining packing of items into minimal or otherwise moderated sets of heterogeneous bins (e.g., cartons or other types of containers). In some embodiments, a constraint solver of the warehouse management system minimizes or otherwise moderates the number of shipping containers required to package and ship a group of items. Packaging configurations may be based on multi-dimensional considerations of item properties, bin capacities, such as weight and volume capacities, ordering and grouping rules, and packaging restrictions. Given a set of items, each with a given weight and volume, for example, and a set of containers, each with a specified weight and volume capacity, the goal is to compute carton placement for each item. It is understood that in addition to geometric and numeric constraints, non-geometric and non-numeric constraints may be declared, such as item compatibility, warehouse storage location, expiration date, place or country of origin, and the like. Container selection may be performed such that the overall number of cartons required for packaging is minimized or otherwise moderated. Optionally, containers chosen for each group of packaged items may be chosen to minimize or otherwise moderate wasted space, while respecting item ordering and grouping.

The constraint programming model formulates the packing problem as a multidimensional vector packing problem, where item properties, container properties, ordering restrictions and packaging restrictions are represented by variables organized into vectors, arrays, or other data structures. Variables in the constraint model include item instances, where each item instance variable is associated with a domain containing a set of elements that are the available container instances, generally represented by an alphanumeric character value. The domains may be organized into data structures such as one-dimensional arrays (e.g., vectors). In some embodiments, preferential search elements are included to guide the constraint problem towards an optimal solution. Multiple search techniques may be employed.

In some embodiments, a computer-implemented method includes storing item characteristics for a plurality of item types. The item types have characteristics such as item volume, item weight, and as noted above, other attributes such as expiration date, country of origin, warehouse storage location, and other attributes that can be bases for constraints. Container characteristics are also stored for a plurality of container types. The container characteristics comprise a container type volume capacity and a container type weight capacity. A plurality of data structures is generated for each item of a plurality of item instances. Each of the data structures holds a set of candidate container instances belonging to one or more container types of the plurality of container types for each item of the plurality of item instances. A particular item instance of the plurality of item instances is assigned to a first candidate container instance. The choice of the first candidate container instance may be determined on the basis of the compatibility of the weight and volume of the particular item instance with the container type (e.g., placing the item instance into the first candidate container instance does not exceed the weight and volume capacities of the container type). An aggregate weight and volume consumed in the first candidate container instance is updated at least in part on the basis of: a particular container type volume capacity for the particular container type; a particular container type weight capacity for the particular container type; a particular item type volume for the particular item type, and a particular item type weight for the particular item type. At least one of the plurality of data structures is modified to enforce one or more logical constraints of a plurality of logical constraints. The one or more logical constraints remove, for one or more item instances of the plurality of item instances, candidate container instances of at least one container type, from the set of candidate container instances of the one or more container types. The plurality of logical constraints may comprise a weight constraint, a volume constraint, and one or more other constraints. The assigning, the updating, and the modifying are repeated in one or more other iterations for one or more other item instances as the particular item instance of the plurality of item instances. In at least one of the one or more other iterations, modifying at least one of the plurality of data structures to enforce the one or more logical constraints results in an assignment of a second item instance to a second candidate container instance of a second container type as an only non-empty remaining candidate container instance for the second item instance. After the one or more iterations, the plurality of item instances is assigned to a plurality of container instances of the one or more container types of the plurality of container types. The container type of at least one of the plurality of container instances may be adjusted to reduce a cost of the plurality of container instances. A blueprint comprising assignments of the plurality of item instances to the plurality of container instances is transmitted to a consumer device. The consumer device may be a display device, for example.

In a further embodiment, the computer-implemented method includes selecting the one or more logical constraints of the plurality of logical constraints as constraints that are potentially affected by assigning the particular item instance to the first container instance. The one or more selected logical constraints are evaluated against any data structures that are potentially affected by assigning the particular item instance to the first candidate container instance. A particular data structure of the plurality of data structures is updated to indicate that candidate container instances other than the first candidate container instance are not available for assignment to the particular item instance corresponding to the particular data structure, in later iterations of assigning, updating and modifying, where the later iterations comprise the one or more other iterations. Another particular data structure of the plurality of data structures is updated to indicate that a particular candidate container instance is not available for assignment to another particular item instance, corresponding to the other particular data structure, in the later iterations of assigning, updating and modifying.

In a further embodiment, the computer-implemented method includes selecting the one or more logical constraints of the plurality of logical constraints as constraints that are potentially affected by assigning the particular item instance to the first container instance. The one or more selected logical constraints are evaluated against any data structures that are potentially affected by assigning the particular item instance to the first candidate container instance. A particular data structure of the plurality of data structures is updated to indicate that candidate container instances other than the first candidate container instance are not available for assignment to the particular item instance corresponding to the particular data structure, in later iterations of assigning, updating and modifying, where the later iterations comprise the one or more other iterations. Another particular data structure of the plurality of data structures is updated to indicate that the first candidate container instance is not available for assignment to another particular item instance, corresponding to the other particular data structure, in the later iterations of assigning, updating and modifying, where the other particular item instance is selected for updating based on the other particular item instance matching at least one of the one or more other item types which are incompatible with the particular item instance.

In a further embodiment, the computer-implemented method incudes selecting the one or more logical constraints of the plurality of logical constraints as constraints that are potentially affected by assigning the particular item instance to the first container instance. The one or more selected logical constraints are evaluated against any data structures that are potentially affected by assigning the particular item instance to the first candidate container instance. A particular data structure of the plurality of data structures is updated to indicate that candidate container instances other than the first candidate container instance are not available for assignment to the particular item instance corresponding to the particular data structure, in later iterations of assigning, updating and modifying, where the later iterations comprise the one or more other iterations. Upon detection that the threshold number of container instances has been reached for the particular group, one or more other data structures corresponding to one or more other item instances is updated to indicate that other container instances are not available for assignment to the one or more other item instances in the later iterations of assigning, updating and modifying.

In a further embodiment, the computer-implemented method includes the one or more constraints preventing item instances of the particular item type from being placed in container instances of one or more particular container types. The set of candidate container instances for the particular item instance excludes one or more container instances of the one or more particular container types.

In a further embodiment, the computer-implemented method includes selecting the one or more logical constraints of the plurality of logical constraints as constraints that are potentially affected by assigning the particular item instance to the first container instance. The one or more selected logical constraints are evaluated against any data structures that are potentially affected by assigning the particular item instance to the first candidate container instance. A particular data structure of the plurality of data structures is updated to indicate that candidate container instances other than the first candidate container instance are not available for assignment to the particular item instance corresponding to the particular data structure, in later iterations of assigning, updating and modifying, where the later iterations comprise the one or more other iterations. Upon detection that the threshold number of item instances in the first candidate container instance has been reached, one or more other data structures is updated to indicate that the first candidate container instance is not available for assignment to one or more other particular item instances, corresponding to the one or more other data structures, in the later iterations of assigning, updating and modifying.

In a further embodiment, the computer-implemented method includes selecting the one or more logical constraints of the plurality of logical constraints as constraints that are potentially affected by assigning the particular item instance to the first container instance. The one or more selected logical constraints are evaluated against any data structures that are potentially affected by assigning the particular item instance to the first candidate container instance. A particular data structure of the plurality of data structures is updated to indicate that candidate container instances other than the first candidate container instance are not available for assignment to the particular item instance corresponding to the particular data structure, in later iterations of assigning, updating and modifying, where the later iterations comprise the one or more other iterations. Upon detecting that at least the container type weight capacity and the container type volume capacity for the first candidate container has been reached, one or more other data structures are updated to indicate that the first candidate container instance is not available for assignment to one or more other particular item instances, corresponding to the one or more other data structures, in the later iterations of assigning, updating and modifying.

In a further embodiment, the computer-implemented method includes selecting the one or more logical constraints of the plurality of logical constraints as constraints that are potentially affected by assigning the particular item instance to the first container instance. The one or more selected logical constraints are evaluated against any data structures that are potentially affected by assigning the particular item instance to the first candidate container instance. A particular data structure of the plurality of data structures is updated to indicate that candidate container instances other than the first candidate container instance are not available for assignment to the particular item instance corresponding to the particular data structure, in later iterations of assigning, updating and modifying, where the later iterations comprise the one or more other iterations. Upon detection that all of the selected logical constraints are enforced by the assignment of the particular item instance to the first candidate container instance, a particular data structure corresponding to a particular item instance is updated to indicate that the first candidate container is not available based on a violation of any of the one or more selected logical constraints by assignment of the particular item instance to the first candidate container.

In some embodiments, the plurality of logical constraints comprises: item types of a plurality of item types are not to be packed in incompatible container types of a plurality of container types; one or more of the plurality of container types may not hold beyond a threshold number of distinct item instances; and item instances may not be packed with incompatible other item instances; particular groups of item instances may not be packed in a number of container instances beyond a threshold number of container instances.

In a further embodiment, the computer-implemented method includes backtracking to a prior iteration to prioritize assignment of an unassigned item instance ahead of one or more previously assigned item instances if the one or more logical constraints leave no candidate containers for the unassigned item instance.

In a further embodiment, the computer-implemented method includes retrieving physical containers corresponding to the plurality of container instances in the blueprint for packing physical items corresponding to the plurality of item instances in the blueprint.

In various aspects, a system is provided that includes one or more data processors and a non-transitory computer-readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a constraint model flow chart showing an example packing process for the constraint programing model in accordance with certain aspects.

FIG. 2 illustrates a block diagram of a warehouse management system based on the constraint model illustrated in FIG. 1, in accordance with certain aspects.

FIG. 3 illustrates a comparison of a constraint model approach and an imperative programming approach to solve a simple packing problem example, in accordance with certain aspects.

FIGS. 4A-4C illustrate a complex packing problem example solved by applying the constraint model illustrated in FIG. 1, in accordance with certain aspects.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

Computer-implemented techniques are provided herein for constraint programming model-managed packing of items into containers. A warehouse management system is implemented using non-transitory computer-readable storage media to store instructions which, when executed by one or more processors of a computer system, cause display of the user interface and processing of the received input to manage blueprints of packing specifications. The warehouse management system may be implemented on a local or cloud-based computer system that includes processors and a display for showing the user interface to a user of the warehouse management system for modifying blueprints of packing specifications. The warehouse management system may communicate with client computer systems such as laptops, warehouse equipment displays, or mobile devices for displaying the user interface of the warehouse management system.

A description of the warehouse management system is provided in the following sections:
CONSTRAINT MODEL
WAREHOUSE MANAGEMENT SYSTEM.
CONSTRAINT MODEL PACKING SOLUTION EXAMPLES.
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Constraint Model

The constraint programming model solution assigns items to bins (e.g., containers) by adhering to packaging constraints that are introduced declaratively within a packing management application software such as a warehouse management system. Inputs to the software include an ordered set of items to be packaged, each item having corresponding weight and volume properties. Other inputs include a set of available shipping container types, each with corresponding weight and volume capacity limits. Subsets of items may be optionally grouped, requiring them to be packaged (collocated) together. Some items may be subject to packaging restrictions, which may limit the size and type of container or the items which may be collocated.

Item-bin assignments are represented as constrained variables, where the domain of each item instance is all available container instances. The number of bins available to a particular item instance is upper bounded by the number of available bins. In instances where item types are not homogeneous, multiple item instances belonging to different item types may be assigned to a particular container type according to compatibility constraints. For example, heavy or dense items may not be packaged together with fragile or soft items. Some items may be restricted from being packaged with any other items, and must be packaged as a single type. For example, delicate items may need to be packed only with like items. In another example, hazardous items may need to be packaged by themselves in a special container to comply with shipping regulations and/or not to risk damage or contamination of non-hazardous items.

Bin types may be generally heterogeneous, and all bins may be packed to minimize or otherwise moderate wasted space, where volume margin constraints (e.g., a minimal or deterministically moderated difference between volume capacity of a container type and the volume consumed by assigned items) may be optionally enforced. Bin types also have weight capacity constraints, as containers may be rated to hold up to a certain weight. As used herein, wasted space, number of bins, item compatibilities, shipping cost, and/or any other packing or shipping factor may be “moderated” by the warehouse management system by using techniques that reduce a total amount of resources (bins, money, etc.) used to fewer resources used than the strategy of placing each item into a separate bin.

Bin type is represented as a constrained variable whose domain represents the available bin types. In at least one embodiment, a set of bins in a packing problem are heterogeneous, in that there can be multiple available bin types. For example, bin types are identified by volume capacity and weight capacity. In at least one embodiment, bin types may be constrained to a minimal or moderated size required for packing a group of collocated items on the basis of an aggregate volume of the collocated items and a volume capacity of the bin type and/or volume margin constraint for the bin type, if any. In at least one embodiment, the constraint model solves for one or more bin types that can be employed to pack a particular group of items, where the one or more bin types are selected from a set of heterogeneous bins.

Bin loads may also be represented by constrained variables, which aggregate the weights and volumes of items assigned to a particular bin instance. The aggregated weights and volumes of assigned items are upper bounded by the weight and volume capacities of the particular bin type. Bin load variables are auxiliary variables that are employed to track the utilization of bins.

The constraint model may also employ colocation constraints to restrict the number of containers employed to pack a given set of items. In at least one embodiment, an NVALUE constraint is employed to set a maximum number of containers available for packing items. In at least one embodiment, NVALUE is a counting constraint defined over all container instances. In at least one embodiment, NVALUE is employed to count the number of unique assignments among the bin assignment variables for the items to be collocated. The number of unique assignments is upper bounded by the number of bins determined necessary to pack the items. The NVALUE constraint may be expressed by the following operation:

$$NVALUE ( \{ binOfItem \} ) \leq requiredBinsForItems$$

If only a single bin is required to fit all items, then the value is one. For multiple bins, the variable “requiredBinsForItems” contains the minimum number of bins to contain the items. For example, the constraint model may find a combinatorial permutation of the set of items and available container types that fits into a minimal or otherwise moderated number of cartons or other types of shipping containers.

Items may also be grouped according to orders. In at least one embodiment, grouping constraints are assigned over the bin assignment variables of the item groups. In at least one embodiment, a constraint may employ MAX, MIN and comparison operations (e.g., LESS THAN, GREATER THAN) to enforce grouping constraints. For example,

$$MAX ( \{ binOfItemGroup 1 \} ) < MIN ( \{ binOfItemGroup 2 \} ) .$$

ensuring that the MAX container assignment of a first group of items (e.g., ItemGroup1) is LESS THAN the MIN container assignment of a second group of items (ItemGroup2), so that there is no mixing of Group1 items and Group2 items, and that Group2 items are assigned to a different container than the container to which Group1 items have been assigned. As an example of a grouping constraint, textbooks ordered from a distributor for a classroom may be grouped by individual students or for entire classrooms or schools. Items ordered on-line through web-based commerce sites may be grouped according to customer. The constraint model may take in item grouping constraints as individual orders are input to the packing management application software as soon as the orders are made by the customers. In other instances, grouping constraints may also be based on item compatibilities, item sizes or weights, item form factors, types of containers into which particular items may be placed, to mention a few.

The constraint model may employ global counting constraints (GCC) that track and limit the number of distinct items packed into a container. For example, a global counting constraint may limit a count of a particular item type, optionally counted in combination with other items of the same item type or counted with other items of other item types, to a specific number not to be exceeded within a container. In at least one embodiment, a global counting constraint may employ the following operation:
gcc ({binOfItem], {bin IDs}, {countOfBin})
   This GCC operation ensures that when a bin assignment variable, input to the first parameter, is assigned to a particular bin, stored as a bin ID input to the second parameter, the corresponding counting variable for that particular bin (input to the third parameter) is incremented by one.

As an example, the global counting constraints may limit item A to a ten-count, item B to a five-count, and item C to a twenty-count within a container. Other non-numeric or geometric item characteristics can be used for restricting packing of some items together in the same container. For example, a constraint may be declared to require that items located in a certain warehouse location are to be packed together, and items located in other parts of the warehouse are excluded. Constraints can also restrict items based on compatibilities, such as materials. Here, for example, heavy and dense items (e.g. bricks) cannot be packed with fragile or easily deformable items, such as glass goblets or loaves of bread.

In at least one embodiment, the weight and volume capacities of a container type may optionally be combined as an index for the container type, whereby the index may be a volume capacity to weight capacity ratio for the container type, for example. Thus, the item may be assigned to an empty container having the lowest index. In at least one embodiment, when the item-bin assignments are complete, the constraint model infers for each container the type that accommodates the packed items with minimal or otherwise moderated unpacked space. Here, a volume margin constraint may be enforced, and the constraint model may refine the container search to ensure that sets of items are packed into containers having the smallest or otherwise deterministically moderated unpacked volume.

In at least one embodiment, bin type inference is accomplished by comparing the bin utilization variable against the physical properties of each bin type. Infeasible bin types are removed if the items assigned to the bin exceed the bin type capacities. In at least one embodiment, the constraint model employs an ELEMENT constraint that accomplishes bin type inference. ELEMENT removes an infeasible container type from the set of candidate container types if items assigned to the bin exceed the type capacities, for example, based on the weight and volume capacities of the container type:

$$weightOfBin ( i ) \leq element ( typeOfBin ( i ) , \{ {w}_{1} , {w}_{2} , ... . {w}_{m} \} )$$

$$volumeOfBin ( i ) \leq element ( typeOfBin ( i ) , \{ {v}_{1} , {v}_{2} , ... . {v}_{m} \} )$$

The search function of the constraint model, described below, will then select a bin from the remaining feasible bin types.

As noted above, non-geometric properties could also be used to track and limit items. For example, only items stored in the same area of the warehouse may be packed together. In a further example, only items with same manufacturing origin may be packed together.

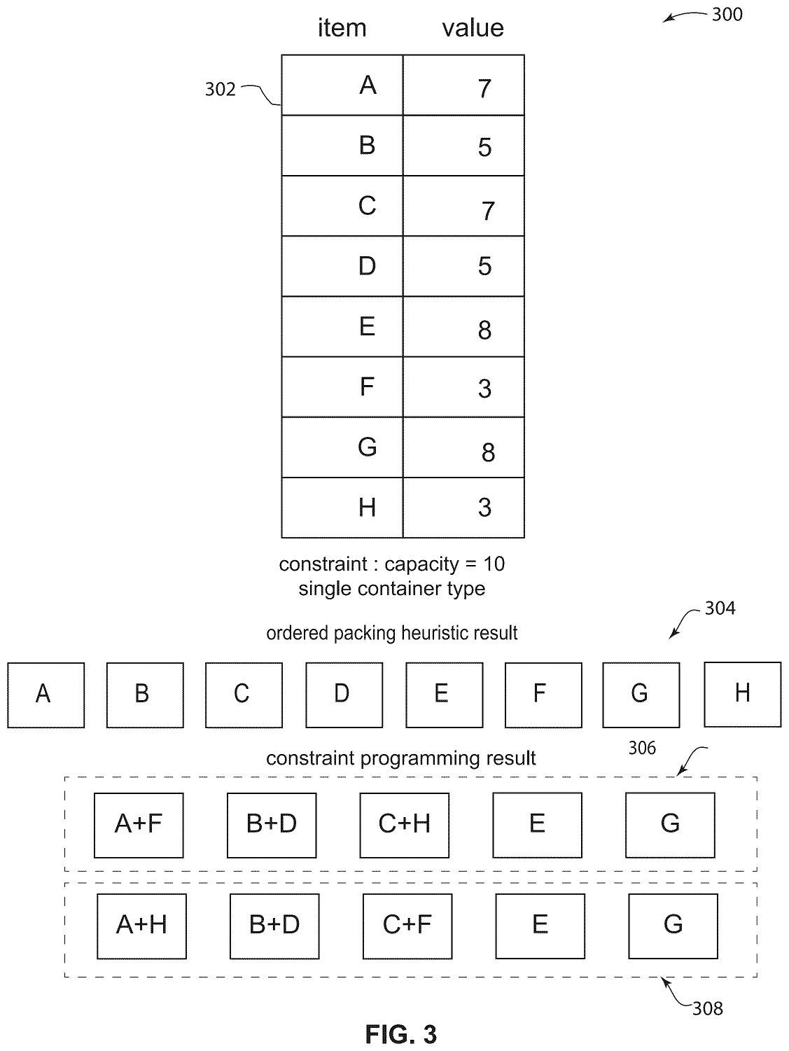

In at least one embodiment, the constraint model searches for a packing problem solution by use of a variable selection heuristic. At the outset, the items are sequenced according to end-user input to a high-level calling program having a user interface, such as a warehouse management system, described below. The packing order of the items is performed lexicographically. Thus, items are first assigned to bins in a sequential order. The heuristic may use a search directive that is added to the constraint model to instruct the search to assign the item-bin assignment variables in their defined order. When bin assignment variables reach a fixed point, the search process then iterates the bin type variables. The search proceeds by selecting one variable and then assigning a value to it. This branching decision triggers propagation and the constraints of the model remove values from the domain for other variables that are inferred to be in conflict with the decision. Once the propagation mechanism reaches a fixed point, the process continues by selecting the next variable. An example of this mechanism is demonstrated in FIG. 3.

For example, a list of items may be input to the packing management application software. The constraint model begins with the first item on the list, and continues down the item list to make bin assignments. Multiple container instances may be opened and progressively filled while the constraint model continues to make assignments for remaining items. To fill containers, items on the list of items are assigned to a partially filled available bins having enough capacity to receive the item and not exceed the resource capacity (e.g., volume and weight capacities) of the containers, where other packaging conditions such as grouping, counting, item/container compatibility constraints are not violated. If a violation would occur by grouping the item with other items in existing containers, the item may be then assigned to an empty container instance having the smallest volume capacity that is not exceeded by the item. In another embodiment, the item is assigned to an empty container instance having the largest volume capacity not exceeded by the item, and container capacities are adjusted in a clean-up phase after the items have been placed into containers.

Resource limitations and utilization are enforced by representing the packing problem as a multidimensional vector packing problem with heterogenous bins. The constraint model assigns items to bins according to bin packing constraints declared at a high level in the constraint model. The bin packing constraints may generally include weight and volume capacities of bin types. In generating item assignments to bin instances, the constraint model enforces these packing constraints by aggregating assigned item weights and volumes, preventing the container capacities from being exceeded.

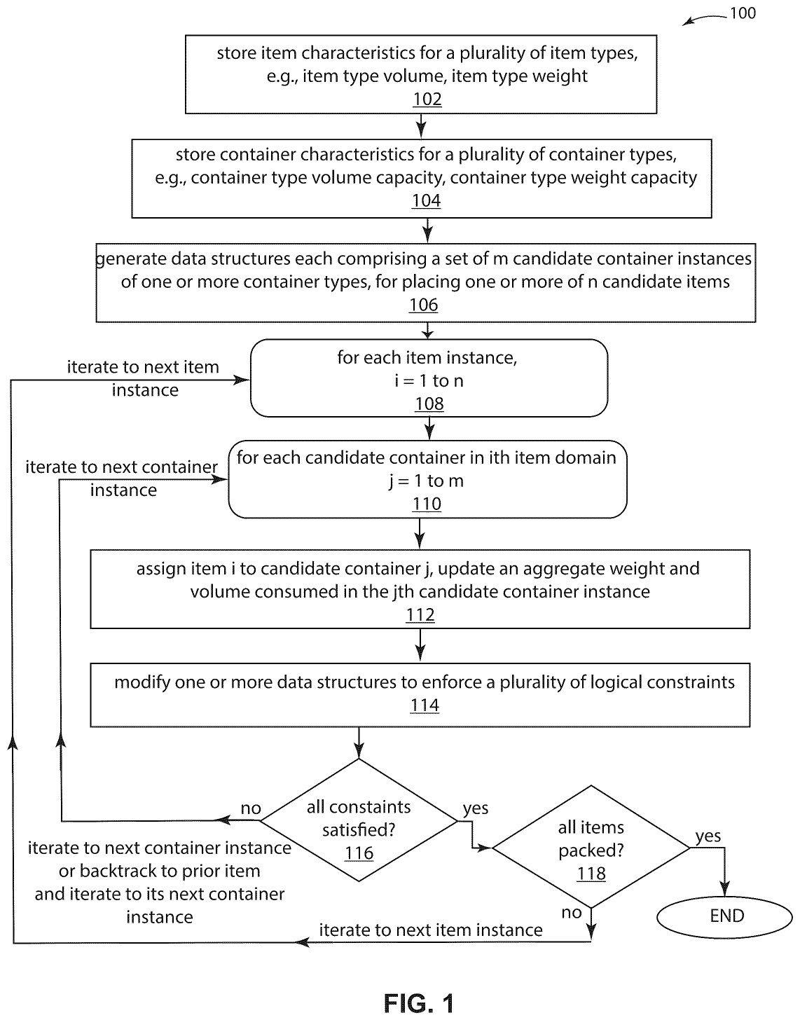

FIG. 1 illustrates a flow chart showing an example packing process 100 for the constraint programing model. FIG. 1 starts at block 102, where property data of items input to the constraint programming model, such as the weight and volume data of the item, are stored in a data storage device. Other item property subsets, such as compatibility data, may also be stored. Property data may be stored into one or more one- or two-dimensional arrays or other suitable data structures. The data storage device may be a cloud drive on a cloud-based server and/or a local drive on a desktop or portable computing device. The database is accessible to the constraint programming model to retrieve the data. Alternatively, such data may be retrieved from a cloud-based server as orders made by individual customers through a web-based commerce site, or by a store or other businesses ordering supplies and inventory from a central distribution center warehouse.

At block 104, container property data, such as container weight capacity and volume capacity data, are stored in a database on a data storage device, such as a cloud drive or local drive accessible to the constraint programming model. These data, including the item property data, may be input to the constraint programming model through a user interface or machine interface managed by the packing management application. The user interface may be displayed graphically on a desktop or mobile device accessible to a human operator at a warehouse, for example. The warehouse may have an inventory of carton containers, where a warehouse management software application may keep track of an inventory of shipping cartons of various sizes and weight capacities. While the examples used throughout this disclosure involve the packing of relatively small shipping cartons at a warehouse facility, the constraint programming model is applicable to solve packing problems for large-scale containers as well. Such large-scale containers may comprise truck loads for delivering large items or for hauling large numbers of cartons and boxes in an overland shipment, as well as cargo containers for overseas shipping. In addition to warehouse distribution centers, packing problems at other logistical distribution facilities, such as shipping docks and stock yards may also be managed by a packing management application employing the constraint programming model.

At block 106, data structures are generated for each item instance. The data structures are generally a one-dimensional (e.g., a vector) or a two-dimensional array containing all available candidate container instances. In one embodiment, candidate container instances are instances of available container types. In another embodiment, candidate container instances are initially generic with respect to a largest container type and are later adjusted in a clean-up phase after items have been placed into the containers, resulting in smaller container types that reduce wasted space but hold the same previously assigned items as their larger container counterparts. Container types may encompass all available container sizes (e.g., volume and form factor), weight capacities and other properties such as materials (e.g., plastic, cardboard, metal), materials compatibility (e.g., waterproofed lining for wet items). The data structures are associated with each item instance by the constraint model. Container types for the candidate container instances may be chosen by item properties. Incompatible container types are excluded. Selection and ordering of container instances may follow rules that may be set up dynamically by users or programmatically, or be retained within the constraint model as static directives.

At block 108, the constraint model iterates through all n item instances after passing control to subsequent blocks up to block 114. Constraint violation or enforcement is checked at block 116, where control is returned to block 110 for the next container iteration (e.g., j+1) if any constraints are violated. The constraint model may iterate through all m available candidate container instances for the ith item, finding no container instance that satisfies any of the constraints. In this situation, the constraint model may backtrack to a previous item iteration (e.g., i−1) then advance the j value in block 112 from the previously assigned jth container in the domain of the (i−1)th item to next j value (e.g., j+1, the (j+1)th container instance) and perform constraint checking in block 116. If necessary, the constraint model iterates through all remaining candidate container instances contained within the domain of the (i−1)th item, up to the mth container instance of its domain until a j value is found where an assignment of the (i−1)th item to that new (e.g., jth) container instance no longer violates all constraints. The new assignment for the (i−1)th item may affect the domains of the remaining unassigned items, for example by eliminating the jth container instance from some item domains. The constraint model then updates those affected domains at block 114, and then advances to item i again to find a new assignment.

At block 110, the constraint model iterates through the candidate container instances listed in the data structure corresponding to the ith item instance for making item assignments to candidate container instances. The number of candidate container instances is upper bounded by the number of available candidate container instances, in this case there are m available candidate container instances. Generally, block 110 may make fewer than m iterations to for the item assignment to be complete.

The constraint model may find a fit for the ith item instances by evaluation of the logical constraints (e.g., packing constraints) that are present. For example, the first item is packed in the first candidate container instance at iteration 1, not to exceed the weight and volume capacities, and not to violate compatibility and other constraints of the first candidate container instance. The weight and volume of the first item instance is tallied. At block 112, the constraint model updates a container packing tally, whereby an aggregate weight and an aggregate volume consumed by the items packed into the container are accumulated after each item is assigned to the first or jth candidate container instance. After the first item instance is assigned to the first container instance, the data structure corresponding to the first item instance is modified at block 114 to eliminate all other available candidate container instances. Thus, the first item instance is assigned to the first candidate container instance and no other candidate containers are available to it.

No further container iteration is necessary for the first item instance, thus program control loops back to block 108 to assign the next item instance. The second item instance may be assigned to the first candidate container instance along with the first item instance, if the container constraints noted above are not violated. Again, at block 112, the aggregate weight and volume consumed for the first container instance is calculated. At block 114, the data structure of the second item instance is modified to indicate that it is assigned to the first candidate container instance (all other candidate container instances are removed from the data structure). As noted above, constraint satisfaction is checked by constraint filter algorithms at block 116. Which is a decision point. If any inconsistent assignments are detected, program flow loops back to block 110, where the loop iterates to the next container instance in the item domain. If all constraints are found to be satisfied at block 116, program flow continues to block 118, where the constraint model keeps track of the number of items that are packed.

The constraint model may continue to assign item instances by repeating the loop iterations between block 118 and block 108, then iterating through all remaining item instances and performing constraint checking and data structure updating at blocks 112 and 114, where the data structures for each item instance (e.g., the item domains) are modified by elimination of any container instances from those particular data structures that are inconsistent with any of the constraints. Item assignments may be made by inference, where an item assignments may be made by a process of elimination. For example, assignment of one item into a container may render the container unavailable to one or more other items. By inference, the filter algorithm for the constraint preventing the one or more other items to be packed with the first, may systematically assign the one or more other items into any of the available containers if no constraints are violated by the assignments.

For each ith item instance, the available unfilled candidate container instances are evaluated by comparison of the ith item instance weight and volume and the weight and volume capacity of the unfilled candidate container. This comparison may be done by comparing the ith item weight and volume to the aggregated weight and consumed volume by the previously packed items for the unfilled candidate container instance. If assignment of the ith item would exceed the weight and volume capacities of the unfilled candidate container instance, then the item is assigned to the next available candidate container instance. The next available candidate container instance begins an aggregate weight and consumed volume tally at block 112.

The previous unfilled candidate container instance may be closed by the constraint model or may be left open to assign other item instances of a different item type that may fit (e.g., their assignment to the unfilled candidate container instance is evaluated at block 112, where their weights and volumes are added to the aggregate weights and consumed volume of the previously assigned items). If the weight and volume capacities of the unfilled candidate container instance are not exceeded, nor other constraints violated (block 116), the next item instances are then assigned to the unfilled candidate container instance. This process is repeated by iteration through remaining item instances at block 108 until either all items are assigned to candidate containers or no other item instances can be found that will not cause the weight and volume capacities of the container to be exceeded. The current, previously unfilled candidate container instance may be considered filled and then closed, whereby no further item assignments are made to it. At block 114, data structures of all remaining unassigned items are modified to indicate that the current container is no longer available to them.

The constraint model continues to iterate through all item instances until no more item instances remain. Other logical constraints are enforced during item assignment as well. For example, compatibility, grouping and numbering constraints are enforced. More specifically, logical constraints may include the following: item types of a plurality of item types are not to be packed in incompatible container types of a plurality of container types; one or more of the plurality of container types may not hold beyond a threshold number of distinct item instances; item instances may not be packed with incompatible other item instances; and particular groups of item instances may not be packed in a number of container instances beyond a threshold number of container instances.

For application of compatibility constraints, at block 114 data structures for other item instances are updated to exclude other items that are incompatible with a particular item from being collocated in the same container instance with the particular item already assigned. For example, as noted above, items having other characteristics that are subject to restrictions by compatibility constraints restricting items from different locations in the same warehouse from being packed together, items having different expiration dates from being packed together, etc. For application of grouping constraints, at block 114 data structures for other item instances are updated to indicate that other container instances are not available for assignment to other item instances that are members of the same item type or group as a particular item type or group already assigned to a particular container instance, and that the other item instances of the same item type or group are assigned to the same container instance. This may also be governed by a number constraint whereby a threshold number of item instances in a particular container instance is not to be exceeded. The data structures of remaining item instances of the same item type or group may then be updated to indicate that the particular container instance is no longer available to remaining item instances. Other candidate container instances may be available to continue the assignment of remaining items to be grouped or packed with identical items.

In addition to the above, a counting constraint may be employed to count the number of unique assignments among the container assignment variables for items to be collocated. This value is upper bounded by the number of containers determined necessary to pack the items. In the case that the items fit within a single available container, this value will be one, otherwise a minimal or otherwise moderated number of bins to contain the items.

If an item is subject to packaging type restrictions, a constraint may be added to enforce that the candidate container instance in which the item is packed is of the restricted type. There may exist in the calling application a condition to separate item packing based on dynamically defined conditions. To support breaking in its most general form, the constraint solution allows for grouping items and defining an ordering among the groups. Constraints are defined over the container assignment variables of the item groups to ensure that the grouped items are assigned to different containers when the grouping requirement is fulfilled within individual container instances.

The number of items assigned to each bin can be computed and constrained by use of a global counting constraint. An index table constraint element may be employed to associate the container type variable to a utilization variable for each physical property of the container. The element constraint uses the container type variable as an index for a lookup table containing the properties associated with each container type. A preferential search directive may be specified in the constraint model to guide the search to assign the item bin assignment variables in a sequentially ordered manner. The constraint problem and its search directives may be used in conjunction with an interruptible iterative optimization algorithm to find an optimal or best solution within an allowed period of time.

### Warehouse Management System

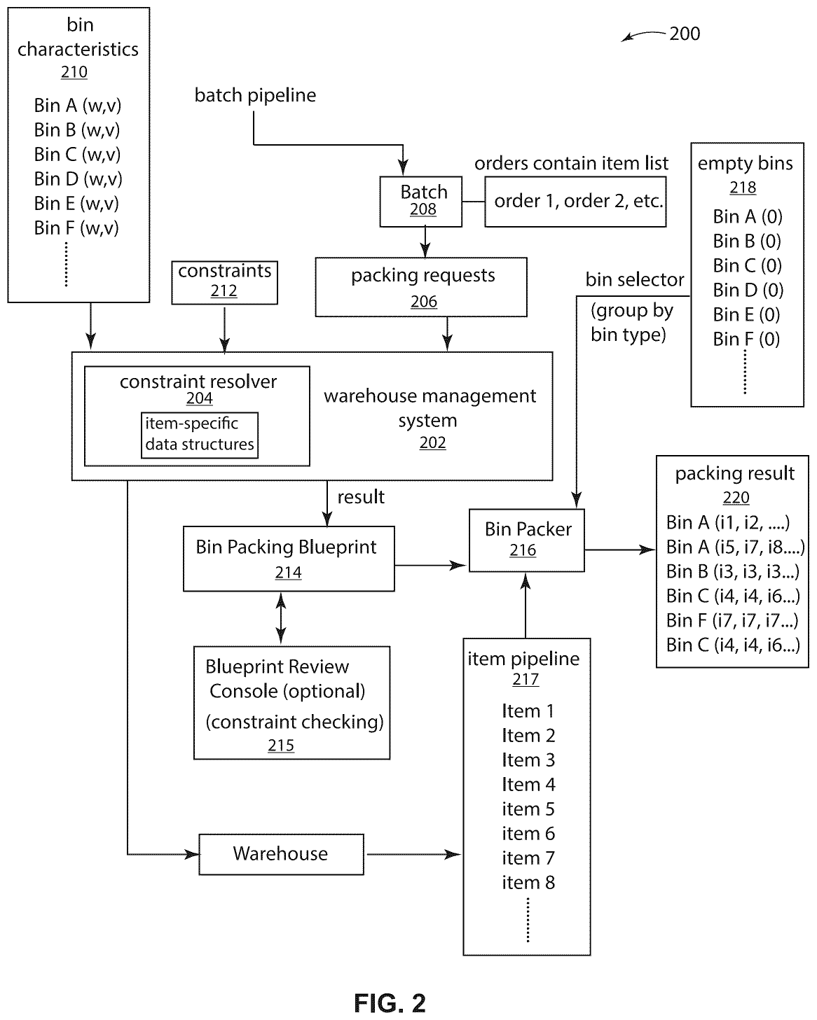

FIG. 2 illustrates a block diagram for a warehouse management system 200. At the center of warehouse management system 200 is a warehouse management application software package 202, which may be stored on a cloud-based server or a local server. A constraint programming packing solver 204 is called by warehouse management application 202, and contains the constraint model described above. The constraint solver software may also be stored on a cloud-based server or on a local server. Warehouse management application 202 is configured to receive packing requests 206, which may be input by one or more users upstream. For example, in internet commerce, batches 208 of orders from numerous customers may be sent along a pipeline by commerce websites associated with the particular warehouse that houses the requested items. In another example, an employee of a warehouse may receive orders directly and manually input the order data into a computing device running the warehouse management application. Orders may be grouped into batches 208 of individual packing requests 206, or single orders may be processed as individual packing requests 206 at a time.

Items inventoried at the warehouse may be listed in a database. Constraint programming packing solver 204 may have access to the database that contains item-specific data structures that correspond to each item. In addition, a set of constraints 212, as described above, is also available to constraint programming packing solver 204. The constraints may be dynamically accessed or statically stored as preset variables. For dynamic access, constraints may be changed by user input or programmatically to suit the packeting requests. Constraint solver 204 may also access a list of container properties 210 for each container type. Container type properties may include weight and volume capacities, form factor, and compatibility data.

Constraint programming packing solver 204 may utilize the constraint model 100 illustrated in FIG. 1 to make virtual assignments of items to containers. After all items requested in packing request 206 are assigned, warehouse management application 202 may generate a container packing blueprint 214. The container packing blueprint 214 may be printed as a hard copy or displayed on a desktop computer or portable/mobile device, and include a specification of which items are assigned to which containers as well as instructions for packing the physical containers with the physical items, optionally including additional metadata about the items or containers such as packing steps or warnings, such as “fragile”. In an example blueprint, a list of physical container types may be included, as well as the number of instances of each container type. The items to be packed are also listed for each container instance. Container packing blueprint 214 may be sent to a bin packer 216, such as a machine consuming container instances and/or items via a conveyor belt with items and/or containers ordered on the conveyor belt according to the blueprint, and/or a robot or device-assisted agent selecting containers from a container staging area and/or items from an item staging area to fill the containers with the items according to the blueprint. Container packing blueprint 214 may optionally be checked by a blueprint review console 215 to check or confirm that all logical constraints have been observed.

Bin packer 216 is tasked with physically packing physical items 217 into available empty containers 218 according to container packing blueprint 214. Empty containers 218 may be listed in container packing blueprint in a specific order. Bin packer 216 may pull items 217 from shelves in the warehouse in a specific order to most efficiently fill empty containers 218. The items 217 may be ordered in a logical sequence related to location within the warehouse. Items 217 may also be ordered by groups. Empty containers 218 may be ordered to fill most efficiently, whereby containers of specific types may be filled first by items appearing early in the ordering list.

A packing result 220 may be achieved after all items 217 listed in packing request 208 are packed. Packing result 220 may comprise multiple container instances from the same container type.

### Constraint Programming Packing Examples

FIG. 3 illustrates a comparison of a constraint model approach and an imperative programming approach to solve a simple packing problem example 300. The packing problem example 300 comprises a two-dimensional matrix 302 holding eight items consecutively labeled A through H in the first column, each having an associated numeric value less than the number 10, listed in adjacent cells of the second column. The packing problem can be stated as finding an optimal solution whereby the eight items A-H into as few containers, or bins, as possible. An unlimited number of homogeneous bins (single container type) are available for packing the eight items. Each container instance has a capacity of 10, which carries a logical constraint that the value of 10 is not to be exceeded by items packed into a particular container instance.

A heuristic approach may be taken by a sequential, imperative programming approach that uses heuristics to search for a solution to the packing problem. The result is presented as ordered packing solution 304. Here, each item has been assigned separately to a container instance. Again, each container is identical, and the constraint of 10 is applied to all containers. The heuristic follows an algorithm where containers are considered sequentially one at a time. Item A having a value of 7 may be packed into a first container without exceeding the logical constraint of 10. The heuristic followed by the imperative packing algorithm may direct that the algorithm assigns one item to a container instance sequentially. Once an item is assigned to a container instance, the algorithm moves on to the next container instance and assigns the next item to it. The algorithm iterates to the next container instance, and assigns the next available item, until all items have been assigned to a container instance. The algorithm does not return to the previous containers to rearrange packing assignments for minimizing or otherwise moderating the number of packed containers. While the algorithm enforces the logical constraint of 10, it does not assign more than one item per container.

A constraint programming packing solution 306 is shown below ordered packing solution 304. Here, item assignments are arranged so that a minimum or otherwise moderated number of containers are packed. The constraint programming approach reasons about the entire packing problem at the same time. The difference between the imperative programming approach and the constraint programming approach is that for the latter, the containers are not exclusive to the first item assigned to them, whereas in the former they are. The constraint model evaluates all containers in a non-sequential manner, where each container is evaluated for each item, as in blocks 108 through 114 in FIG. 1. The constraint model considers the containers' aggregated capacities simultaneously, and does not exclude container instances that are partially filled. Thus, partially filled containers are still considered as candidates for any particular item instance. Item assignments may be made non-sequentially (e.g., out of sequential order). The item instance will be assigned to an available candidate container as long as the constraints are not violated. This item F may be packed with item A. Item D may be packed into the second container with item B, item H with item C, as these packing assignments do not violate the constraint. Alternatively, a constraint programming packing solution 308 can be presented where item H can also be packed with item A, and item F can also be packed with item C, without violating the constraint. The two solutions 306 and 308 are possible because the constraint model may consider multiple combinations of items simultaneously.

If the imperative programming approach does consider partially filled containers as candidates for remaining items, it does so sequentially. For example, if item A is assigned to the first container, the constraint is evaluated and found not to be violated. The sequential algorithm may then search for an item that can fit with item A. The first item it will find is item F. The sequential algorithm may present a solution identical to solution 306, but it will not present solution 308. While both solutions are identical in this example, in more complex examples, simultaneous alternative solutions may present better options.

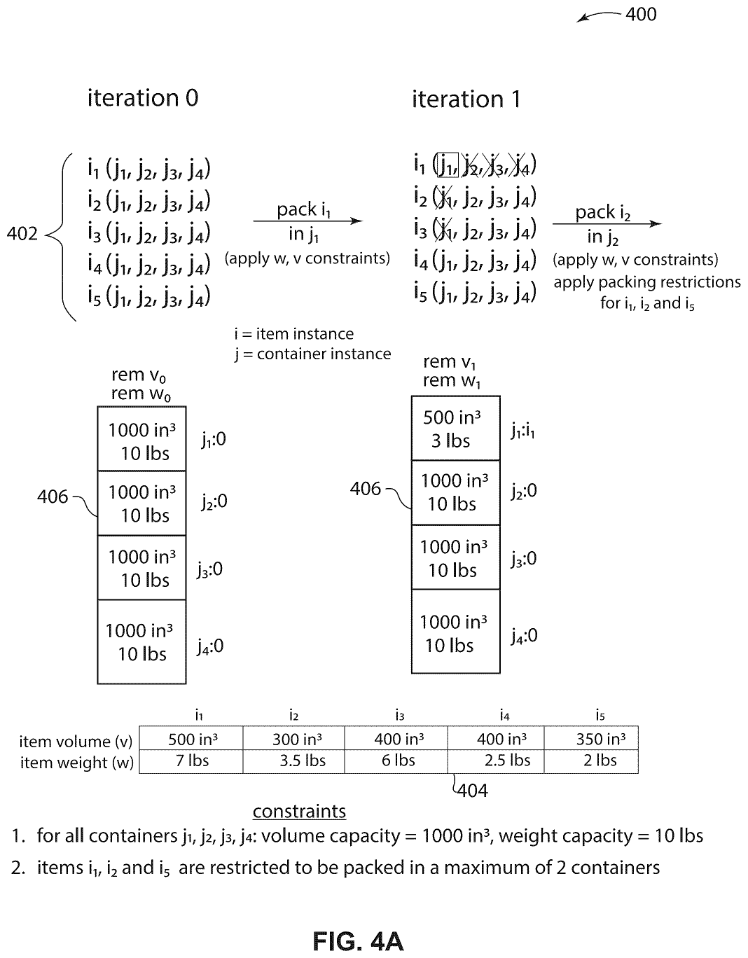

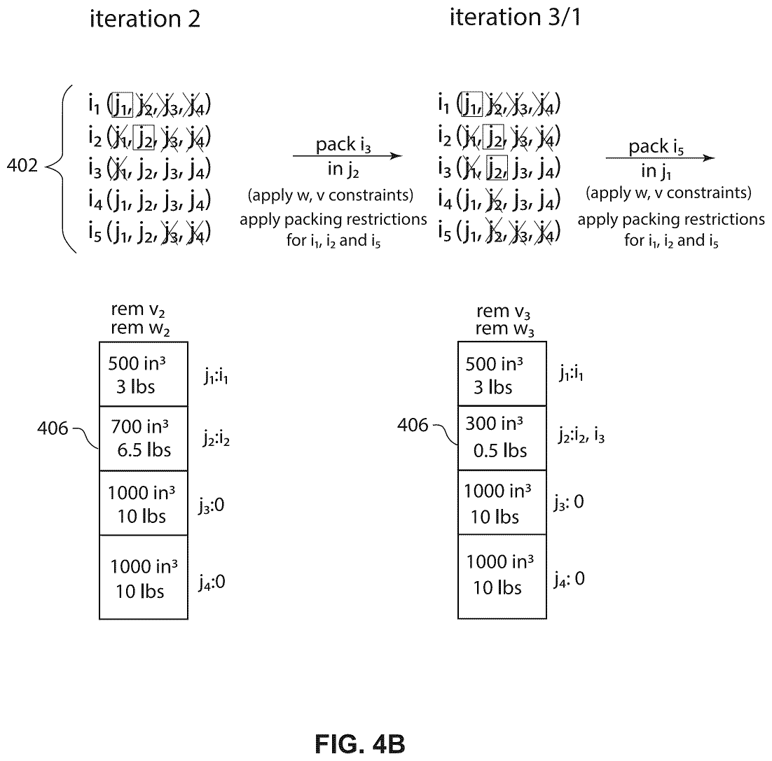

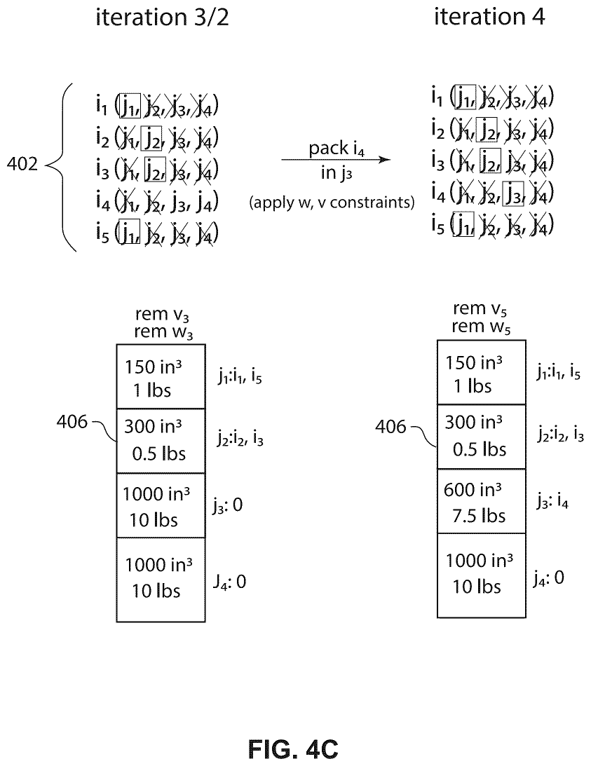

FIGS. 4A, 4B and 4C illustrate a more complex packing problem example 400 solved by applying the constraint model illustrated in FIG. 1. In FIG. 4A, a list 402 of five items i₁, i₂, i₃, i₄ and i₅ is presented, whereby a set of four identical container instances j₁, j₂, j₃ and j₄ are listed in the domain for each item (e.g., in (j₁, j₂, j₃, j₄)). Constraints are stated to enforce the weight and volume capacities of the containers, whereby they are 1) 10 lbs. and 1000 in³, respectively, and 2) items 1, 2 and 5 are to be packed in a maximum of two containers. The weights and volumes for each item are shown in array 404. The assignment statuses for each container are shown in array 406. The values stated within each cell of array 406 indicate remaining weight (rem w) and volume (rem v) capacities of each container j₁ through j₄. Iteration 0 shows an initial state, where no item assignments have been made to any of the four containers j₁ through j₄, indicated in the domains for each of item i₁ through is. When an assignment of an item has been made to a container, for example item 1 to j₁, a box is placed about the j1 (in general, about the container instance receiving the item assignment within the domain), whereby the notation shows i₁(j₁ (boxed), j₂, j₃, j₄). No markup made to the other container instances means that the unmarked containers are also available the item. If a container instance is no longer available to an item, for example, item 1, this may be indicated by striking out the unavailable container instance, for example, j3, whereby the notation shows i₁(j1 boxed, j2, j4). In the figure, the strike-out is indicated by an X rather than a line. Thus, at iteration 0, all container instances j₁ through j₄ are candidate containers for all items i₁ through i₅.

FIG. 4A shows iteration 1 following iteration 0. Here, the first assignment is made. Item 1 is assigned to container j₁. The assignment is indicated by the box about j₁ in the domain of item 1. Containers j₂, j₃ and ja are simultaneously eliminated from the domain of item 1, as indicated by the X strikes through those container instances. Thus, containers j₂, j₃ and j₄ are no longer available to item 1 since it is now assigned to container j₁. Since this is the first assignment, only the weight and volume capacity constraint is enforced. The container status in array 406 is updated for j₁, showing the remaining weight and volume capacity for container j₁ is reduced to 500 in³ and 3 lbs. due to the assignment of item 1. Simultaneously, by evaluation of the weight and volume capacity constraint for each container, container j₁ is removed from the domains of items 2 and 3, since item 1 has already been assigned to container j₁, and has consumed enough weight and volume capacity to exclude items 2 and 3 from being packed therein. The removal of container j₁ from the domains of items 2 and 3 is indicated by striking j₁ from both domains.

FIG. 4B shows the progression of the constraint model in iterations 2 and 3. In iteration 2, item 2 is assigned to container j₂ since it is too heavy to fit into container j₁. This is indicated by the box about j₂ in the domain of item 2. The assignment of item 2 into j₂ does not exclude any remaining item from being packed into j₂, thus j₂ is not struck from the domains of items 3, 4 and 5. However, containers j₁, j₃ and j₄ are eliminated from the domain of item 2, since j₁ was not available to item 2 due to weight restriction, and containers j₃ and j₄ are no longer available to item 2 since item 2 has been assigned. Since items 1 and 2 are now assigned, the constraint model evaluates the second constraint, requiring items 1, 2 and 5 to be packed in two containers. Item 1 is assigned to container j₁, and item 2 is assigned to container j₂, thus contains j₃ and j₄ are no longer available to item 5 since it must be packed with either item 1 or item 2. The packing status of j₂ is updated in array 406, showing remaining weight capacity of 6.5 lbs. and volume capacity of 700 in³.

Iteration 3 is split into two phases, iteration 3/1 and iteration 3/2 (shown in FIG. 4C). At this point, since items 1 and 2 have been assigned in iterations 1 and 2, the second constraint is evaluated, limiting items 1, 2 and 5 to two containers maximum. Since items 1 and 2 have been assigned separate containers, item 5 may be considered for packing with item 1 or item 2. In the first phase, item 3 is assigned to j₂ since there is enough capacity to accommodate item 3 and not enough in container j₁. After assignment of item 3 to container j₂, container j₂ is no longer available to item 5 due to capacity restrictions. The packing status of j₂ is updated to indicate remaining capacity of 300 in³ and 0.5 lbs.

Turning now to FIG. 4C, in the second phase of iteration 3, item 5 is assigned to container j₁. Thus, the second constraint has been enforced, that items 1, 2 and 5 are packed into no more than two containers. To perform the item assignments, the constraint programming model uses inference, where the model invokes a systematic search function and filtering algorithms to find inconsistent item assignments to container instances, where the inconsistencies are defined by each constraint. Container instances are enumerated in the domains of each item instance. The search algorithm may enumerate all combinations of container assignments and define a search tree, where each node of the tree is evaluated for inconsistent item assignments by each of the filtering algorithms associated with each constraint. The filtering algorithms evaluate a particular assignment of an item to a container, for example, assignment of item i₃ to container j₂. Evaluation of assignment combinations by a filtering algorithm associated with the weight and volume constraints eliminated j₂ from the domain of i₅. By inference, the only valid assignment choice for i₅ is j₁ following assignment of i₃. Thus the constraint model makes the final assignment by placing is in j₁ by inference.

Following iteration 3, the constraint model iterates to iteration 4, whereby item 4, the only remaining item, is assigned to one of the available containers, j₃ or j₄, which are empty. Containers j₁ and j₂ are not available to item 4. The constraint model may assign item 4 to either container j₃ or j₄ as these are both still empty as assignment of item 4 will not exceed the weight and volume capacities of either container. In the illustrative example, item 4 is assigned to j₃. While packing problem example 400 is exemplary, it will be understood that other constraint programming solutions are also possible. For example, item 4 may have been packed into j₄ without loss of efficiency. Item 3 may also have been packed with item 4, and item 5 may have been packed with item 2, without violating constraints or reducing efficiency.

Another feature of the constraint programming model is that breaking conditions can be user-defined and implemented to create desired groupings of items. An example is demonstrated in retail ordering of books for a school. The school order consists of two textbooks for each of six students divided into three classrooms. Thus, 12 books are ordered from a publisher, through a textbook distribution center. The two textbooks per student are different item types, each item type having six instances. The 12 book instances may be shipped in different sized shipping cartons depending on cost factors. Container choices are small boxes, medium-sized boxes and large boxes. Depending on the most economical way to pack and ship the books may be predetermined by an algorithm in a preprocessing stage of the warehouse management application, either programmatically or manually by the warehouse employee. Breaking conditions may be set by choice of the most economical way to ship the 12 textbooks. In some embodiments, container (bin) assignments may be stored in a variable binOfItem-n [1 . . . numBins]. Breaking conditions may be created by grouping items into multiple groups. Thus, assignments can be grouped by use of binOfItem variable:

$$binOfItem - 11 ] through binOfItem - m [ 1 … ] \qquad Group 1$$

$$binOfItem - m + 1 [ 2 … ] through binOfItem - n [ 2 … ] \qquad Group 2$$

$$binOfItem - n + 1 [ . N .. ] through binOfIttem - z [ N … ] \qquad Group N$$

Where group 1 is packed in container 1, group 2 is packed in container 2, group N is packed in container N, etc. Breaking conditions may be enforced by applying a break-by condition, whereby

$$max ( binOfItem - Group 1 [ 1 ] ) < min ( binOfItem - Group 2 [ 2 ] )$$

The total number of cartons may be determined by a variable TotalNumBoxes [0 . . . numBins]. Using this variable, cartons may be counted by the following relation:

$$TotalNumBoxes = binPacking ( binOfItem [ ] , volumeOfItem [ ] , volumeOfBin )$$

In the case of breaking conditions for the textbook order, the 12 textbooks may be grouped by breaking conditions requesting break by classroom, break by student, or break by order, whereby the textbooks are grouped into two item types. For breaking conditions, grouping assignments may be made by setting the binOfItem [ ] variable. For example, two large-sized boxes are chosen for shipping, thus items are broken into two boxes, holding six books each. Books may be randomly packed in each box, box 1 and box 2. Item 1 is book 1, Item 2 is book 2, Item 3 is book 3, etc., where the books are not ordered by item type. Container 1 is box 1 and container 2 is box 2. The assignment variables may be set to indicate assignments by the following notation:

binOfItem-1 [1], binOfItem-2 [1]. binOfItem-3 [1]... . binOfItem-6 [1]
binOfItem-7 [2], binOfItem-8 [2], binOfItem-9 [2]... binOfItem-12 [2]

Breaking conditions may call for breaking by classroom, of which there are three. Thus, assignment variables may be set by box 1, box 2 and box 3, which may be medium-sized boxes. Hence,

binOfItem-1 [1], binOfItem-2 [1]. binOfItem-3 [1], binOfItem-4 [1]
binOfItem-5 [2], binOfItem-6 [2], binOfItem-7 [2], binOfIem-8 [2]
binOfItem-9 [3], binOfItem-10 [3], binOfItem-11 [3]. binOfItem-12 [3]

The order may call for shipping to each of six students. Breaking conditions may then call for breaking the order into six small boxes, holding two books each. The assignment variables may be set by box 1, box 2, etc., through box 6. Hence,

binOfIttem-1 [1]. binOfItem-2 [1]
binOfItem-3 [2], binOfItem-4 [2]
binOfItem-5 [3], binOfItem-6 [3]
...
binOfItem-11 [6], binOfItem-12 [6]

The constraint programming model may also find more economical packing solutions by imposing constraints such as minimum volume margin constraints, whereby items may be packed to minimize unpacked volume in a container. If cost data for container choices are available to the constraint programming model, then the model may search for the most economical solution when requested for consideration. For example, the model may determine that two large boxes may cost $30, and are a more expensive solution than three medium-sized boxes that would cost $27. A comparison may be made against shipping six small boxes to six students. For example, six small boxes may cost $30, a more expensive solution than the three-box solution.

The three alternative breaking conditions may also be presented to a customer, and the final choice is left to the customer to make. In this scenario, the constraint programming model may be directed to run the packing solver multiple times, through all possible breaking conditions, and present each solution to the user. In this manner, the particular breaking condition does not need to be known a priori.

### Computer System Architecture

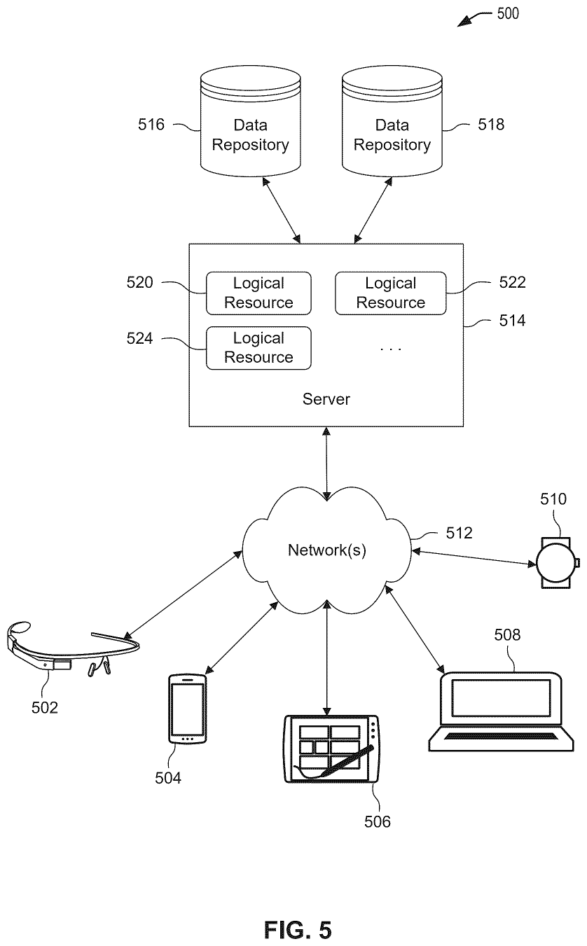

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for constraint programming packing solver.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for constraint programming packing solver in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for constraint programming packing solver. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

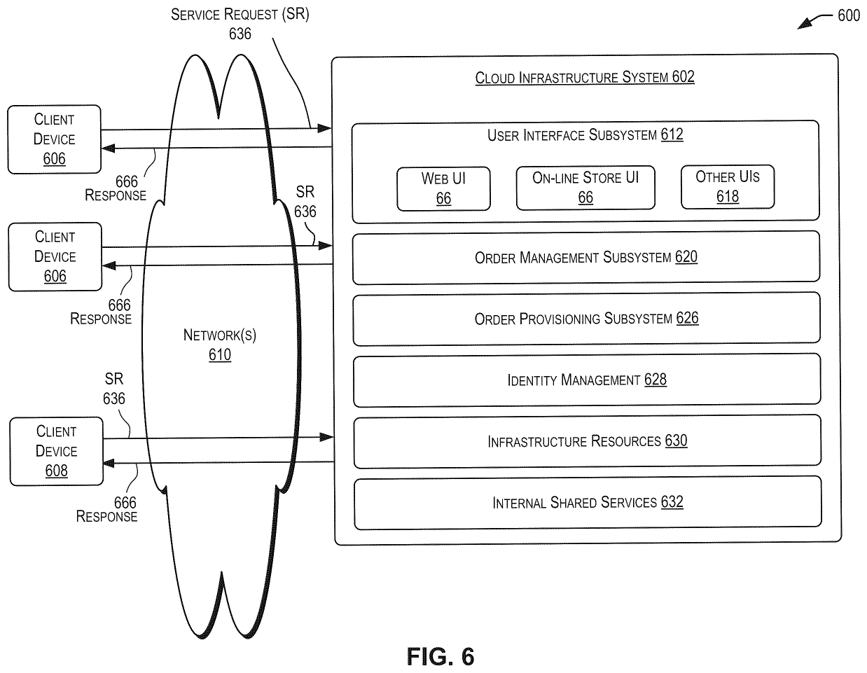

FIG. 6 is a simplified block diagram of a cloud-based system environment in which constraint programming packing solver, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to.

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

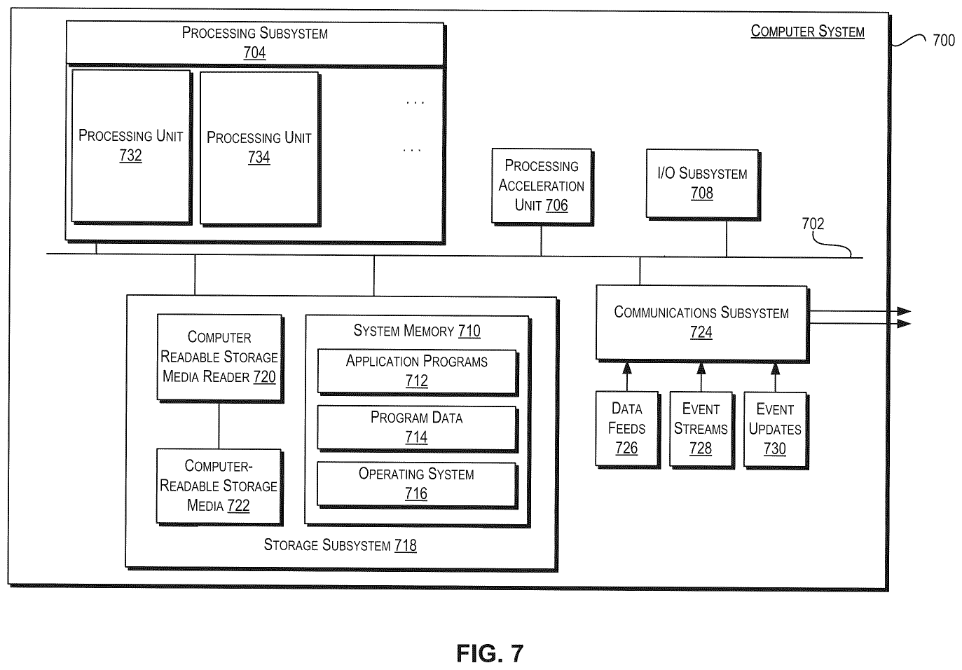

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices.

Communication subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communication subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
storing item characteristics for a plurality of item types, wherein the item characteristics comprise an item type volume and an item type weight;
storing container characteristics for a plurality of container types, wherein the container characteristics comprise a container type volume capacity and a container type weight capacity;
generating a plurality of data structures comprising, for each item instance of a plurality of item instances, a set of candidate container instances of one or more container types of the plurality of container types for placing the item instance;
assigning a particular item instance of the plurality of item instances to a first candidate container instance of the set of candidate container instances for the particular item instance; wherein the particular item instance has a particular item type of the plurality of item types; wherein the first candidate container instance has a particular container type of the one or more container types;
updating an aggregate weight and an aggregate volume consumed in the first candidate container instance based at least in part on:
a particular container type volume capacity for the particular container type,
a particular container type weight capacity for the particular container type,
a particular item type volume for the particular item type, and
a particular item type weight for the particular item type;
modifying at least one of the plurality of data structures to enforce one or more logical constraints of a plurality of logical constraints, wherein the one or more logical constraints remove, for one or more item instances of the plurality of item instances, candidate container instances of at least one container type from the set of candidate container instances of the one or more container types; wherein the plurality of logical constraints comprise a weight constraint, a volume constraint, and one or more other constraints;
repeating the assigning, the updating, and the modifying in one or more other iterations with one or more other item instances as the particular item instance of the plurality of item instances,
wherein, in at least one of the one or more other iterations, modifying at least one of the plurality of data structures to enforce the one or more logical constraints of the plurality of logical constraints results in an assignment of a second item instance to a second candidate container instance of a second container type as an only non-empty remaining candidate container instance for the second item instance;
wherein, after the one or more other iterations, the plurality of item instances is assigned to a plurality of container instances of the one or more container types of the plurality of container types;
adjusting a container type of at least one of the plurality of container instances to reduce a cost of the plurality of container instances;
transmitting, to a consumer device, a blueprint comprising assignments of the plurality of item instances to the plurality of container instances.

2. The computer-implemented method of claim 1, wherein modifying at least one of the plurality of data structures to enforce the one or more logical constraints of the plurality of logical constraints comprises:
selecting the one or more logical constraints of the plurality of logical constraints as constraints that are potentially affected by assigning the particular item instance to the first candidate container instance;
evaluating the one or more selected logical constraints against any data structures that are potentially affected by assigning the particular item instance to the first candidate container instance; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations; and
updating another particular data structure of the plurality of data structures to indicate that a particular candidate container instance is not available for assignment to another particular item instance, corresponding to the other particular data structure, in the later iterations of assigning, updating, and modifying.

3. The computer-implemented method of claim 1, wherein modifying at least one of the plurality of data structures to enforce the one or more logical constraints of the plurality of logical constraints comprises:
selecting the one or more logical constraints of the plurality of logical constraints as constraints that are potentially affected by assigning the particular item instance to the first candidate container instance; wherein a particular selected logical constraint of the one or more selected logical constraints prevent item instances of the particular item type from being placed in a same container instance as other item instances of one or more other item types, wherein at least one of the one or more other item types is incompatible with the particular item instance;
evaluating the one or more selected logical constraints against any data structures that are potentially affected by assigning the particular item instance to the first candidate container instance; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations; and
updating another particular data structure of the plurality of data structures to indicate that the first candidate container instance is not available for assignment to another particular item instance, corresponding to the other particular data structure, in the later iterations of assigning, updating, and modifying, wherein the other particular item instance is selected for updating based on the other particular item instance matching at least one of the one or more other item types which are incompatible with the particular item instance.

4. The computer-implemented method of claim 1, wherein modifying at least one of the plurality of data structures to enforce the one or more logical constraints of the plurality of logical constraints comprises:
selecting the one or more logical constraints of the plurality of logical constraints as constraints that are potentially affected by assigning the particular item instance to the first candidate container instance; wherein a particular selected logical constraint of the one or more selected logical constraints prevents item instances of one or more groups of item types from being assigned to container instances beyond a threshold number of container instances;
evaluating the one or more selected logical constraints against any data structures that are potentially affected by assigning the particular item instance to the first candidate container instance; wherein the particular item type is in a particular group of the one or more groups of item types; and
updating a particular data structure of the plurality of data structures to indicate that candidate container instances other than the first candidate container instance, and that other candidate container instances already holding item instances of the particular group, are not available for assignment to the particular item instance, corresponding to the particular data structure, in later iterations of assigning, updating, and modifying; wherein the later iterations comprise the one or more other iterations; and
detecting that the threshold number of container instances has been reached for the particular group;
updating one or more other data structures corresponding to one or more other item instances having item types in the particular group to indicate that other container instances are not available for assignment to the one or more other item instances in the later iterations of assigning, updating, and modifying.

5. The computer-implemented method of claim 1, wherein one or more other constraints prevent item instances of the particular item type from being placed in container instances of one or more particular container types, and wherein the set of candidate container instances for the particular item instance excludes one or more container instances of the one or more particular container types.

6. The computer-implemented method of claim 1,
selecting the one or more logical constraints of the plurality of logical constraints as constraints that are potentially affected by assigning the particular item instance to the first candidate container instance; wherein a particular selected logical constraint of the one or more selected logical constraints prevents item instances from being assigned to container instances that have already been assigned a threshold number of item instances;
evaluating the one or more selected logical constraints against any data structures that are potentially affected by assigning the particular item instance to the first candidate container instance; wherein the particular item type is in a particular group of one or more groups of item types; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations;
detecting that the threshold number of item instances in the first candidate container instance has been reached; and
updating one or more other data structures to indicate that the first candidate container instance is not available for assignment to one or more other particular item instances, corresponding to the one or more other data structures, in the later iterations of assigning, updating, and modifying.

7. The computer-implemented method of claim 1, wherein assigning a particular item instance of the plurality of item instances to a first candidate container instance of the set of candidate container instances for the particular item instance comprises:
selecting the one or more logical constraints of the plurality of logical constraints as constraints that are potentially affected by assigning the particular item instance to the first candidate container instance, wherein a particular selected logical constraint of the one or more selected logical constraints prevent item instances of the particular item type from being placed in a same container instance as other item instances of one or more other item types such that the one or more selected logical constraints are enforced;
evaluating the one or more selected logical constraints against any data structures that are potentially affected by assigning the particular item instance to the first candidate container instance, wherein the first candidate container instance holds the other item instances of the one or more other item types;
updating a particular data structure of the plurality of data structures to indicate that the first candidate container instance is not available for assignment to the particular item instance, corresponding to the particular data structure, in later iterations of assigning, updating, and modifying; wherein the later iterations comprise the one or more other iterations;
detecting that at least the container type weight capacity and the container type volume capacity of the first candidate container instance has been reached;
updating one or more other data structures to indicate that the first candidate container instance is not available for assignment to one or more other particular item instances, corresponding to the one or more other data structures, in the later iterations of assigning, updating, and modifying.

8. The computer-implemented method of claim 1, wherein a plurality of iterations of assigning adhere to a plurality of logical constraints comprising:
item types of a plurality of item types are not to be packed in incompatible container types of a plurality of container types;
one or more of the plurality of container types may not hold beyond a threshold number of distinct item instances;
item instances may not be packed with incompatible other item instances;
particular groups of item instances may not be packed in a number of container instances beyond a threshold number of container instances;
wherein one or more logical constraints of the plurality of logical constraints may be selected for:
selecting one or more logical constraints of the plurality of logical constraints as constraints that are potentially affected by assigning the particular item instance to a candidate container instance, wherein a particular selected logical constraint of the one or more selected logical constraints prevent item instances from being placed in the first container instance such that the one or more selected logical constraints are enforced;
evaluating the one or more selected logical constraints against any data structures that are potentially affected by assigning the particular item instance to the first candidate container instance, wherein the first candidate container instance holds the other item instances of the one or more other item types;
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations;
detecting that all of the selected logical constraints are enforced by the assignment of the particular item instance to the first candidate container instance; and
updating a particular data structure corresponding to a particular item instance for which a first candidate container is not available based on a violation of any of the one or more selected logical constraints of the plurality of logical constraints by assignment of the particular item instance to the first candidate container.

9. The computer-implemented method of claim 1, wherein modifying at least one of the plurality of data structures to enforce the one or more logical constraints of the plurality of logical constraints further comprises:
if the one or more logical constraints leave no candidate containers for an unassigned item instance, backtracking to a prior iteration to prioritize assignment of the unassigned item instance ahead of one or more previously assigned item instances.

10. The computer-implemented method of claim 1, wherein adjusting the container type moderates unpacked volume in the at least one of the plurality of container instances, wherein the consumer device comprises a container packing device, the computer-implemented method further comprising:
retrieving physical containers corresponding to the plurality of container instances in the blueprint for packing physical items corresponding to the plurality of item instances in the blueprint.

11. A computer-program product comprising one or more non-transitory machine-readable storage media, including stored instructions configured to cause a computing system to perform a set of actions including:
storing item characteristics for a plurality of item types;
storing container characteristics for a plurality of container types, wherein the container characteristics comprise a container type volume capacity and a container type weight capacity;
generating a plurality of data structures comprising, for each item instance of a plurality of item instances, a set of candidate container instances of one or more container types of the plurality of container types for placing the item instance;
assigning a particular item instance of the plurality of item instances to a first candidate container instance of the set of candidate container instances for the particular item instance; wherein the particular item instance has a particular item type of the plurality of item types; wherein the first candidate container instance has a particular container type of the one or more container types;
updating an aggregate weight and an aggregate volume consumed in the first candidate container instance based at least in part on:
a particular container type volume capacity for the particular container type,
a particular container type weight capacity for the particular container type,
a particular item type volume for the particular item type, and
a particular item type weight for the particular item type;
modifying at least one of the plurality of data structures to enforce one or more logical constraints of a plurality of logical constraints; wherein the one or more logical constraints remove, for one or more item instances of the plurality of item instances, candidate container instances of at least one container type from the set of candidate container instances of the one or more container types; wherein the plurality of logical constraints comprise a weight constraint, a volume constraint, and one or more other constraints;
repeating the assigning, the updating, and the modifying in one or more other iterations with one or more other item instances as the particular item instance of the plurality of item instances;
wherein, in at least one of the one or more other iterations, modifying at least one of the plurality of data structures to enforce one or more logical constraints of the plurality of logical constraints results in an assignment of a second item instance to a second candidate container instance of a second container type as an only non-empty remaining candidate container instance for the second item instance;
wherein, after the one or more other iterations, the plurality of item instances is assigned to a plurality of container instances of the one or more container types of the plurality of container types;
adjusting a container type of at least one of the plurality of container instances to reduce a cost of the plurality of container instances;
transmitting, to a consumer device, a blueprint comprising assignments of the plurality of item instances to the plurality of container instances.

12. The computer-program product of claim 11, wherein the set of actions further includes:
selecting the one or more logical constraints of the plurality of logical constraints as constraints that are potentially affected by assigning the particular item instance to the first candidate container instance;
evaluating the one or more selected logical constraints against any data structures that are potentially affected by assigning the particular item instance to the first candidate container instance; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations; and
updating another particular data structure of the plurality of data structures to indicate that a particular candidate container instance is not available for assignment to another particular item instance, corresponding to the other particular data structure, in the later iterations of assigning, updating, and modifying.

13. The computer-program product of claim 11, wherein the set of actions further includes:
selecting the one or more logical constraints of the plurality of logical constraints as constraints that are potentially affected by assigning the particular item instance to the first candidate container instance; wherein a particular selected logical constraint of the one or more selected logical constraints prevent item instances of the particular item type from being placed in a same container instance as other item instances of one or more other item types, wherein at least one of the one or more other item types is incompatible with the particular item instance;
evaluating the one or more selected logical constraints against any data structures that are potentially affected by assigning the particular item instance to the first candidate container instance; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations; and
updating another particular data structure of the plurality of data structures to indicate that the first candidate container instance is not available for assignment to another particular item instance, corresponding to the other particular data structure, in the later iterations of assigning, updating, and modifying, wherein the other particular item instance is selected for updating based on the other particular item instance matching at least one of the one or more other item types which are incompatible with the particular item instance.

14. The computer-program product of claim 11, wherein the set of actions further includes:
selecting the one or more logical constraints of the plurality of logical constraints as constraints that are potentially affected by assigning the particular item instance to the first candidate container instance; wherein a particular selected logical constraint of the one or more selected logical constraints prevents item instances of one or more groups of item types from being assigned to container instances beyond a threshold number of container instances;
evaluating the one or more selected logical constraints against any data structures that are potentially affected by assigning the particular item instance to the first candidate container instance; wherein the particular item type is in a particular group of the one or more groups of item types; and
updating a particular data structure of the plurality of data structures to indicate that candidate container instances other than the first candidate container instance and that other candidate container instances already holding item instances of the particular group are not available for assignment to the particular item instance, corresponding to the particular data structure, in later iterations of assigning, updating, and modifying; wherein the later iterations comprise the one or more other iterations; and
detecting that the threshold number of container instances has been reached for the particular group;
updating one or more other data structures corresponding to one or more other items having item types in the particular group to indicate that other container instances are not available for assignment to the one or more other items in the later iterations of assigning, updating, and modifying.

15. The computer-program product of claim 11 wherein the set of actions further includes:
selecting the one or more logical constraints of the plurality of logical constraints as constraints that are potentially affected by assigning the particular item instance to the first candidate container instance; wherein a particular selected logical constraint of the one or more selected logical constraints prevents item instances from being assigned to container instances that have already been assigned a threshold number of item instances;
evaluating the one or more selected logical constraints against any data structures that are potentially affected by assigning the particular item instance to the first candidate container instance; wherein the particular item type is in a particular group of one or more groups of item types; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations;
detecting that the threshold number of item instances in the first candidate container instance has been reached; and
updating one or more other data structures to indicate that the first candidate container instance is not available for assignment to one or more other particular item instances, corresponding to the one or more other data structures, in the later iterations of assigning, updating, and modifying.

16. A system comprising:
one or more processors;
one or more non-transitory computer-readable media storing instructions, which, when executed by the system, cause the system to perform a set of actions including:
storing item characteristics for a plurality of item types, wherein the item characteristics comprise an item type volume and an item type weight;
storing container characteristics for a plurality of container types, wherein the container characteristics comprise a container type volume capacity and a container type weight capacity;
generating a plurality of data structures comprising, for each item instance of a plurality of item instances, a set of candidate container instances of one or more container types of the plurality of container types for placing the item instance;
assigning a particular item instance of the plurality of item instances to a first candidate container instance of the set of candidate container instances for the particular item instance; wherein the particular item instance has a particular item type of the plurality of item types; wherein the first candidate container instance has a particular container type of the one or more container types;
updating an aggregate weight and an aggregate volume consumed in the first candidate container instance based at least in part on:
a particular container type volume capacity for the particular container type,
a particular container type weight capacity for the particular container type,
a particular item type volume for the particular item type, and
a particular item type weight for the particular item type;
modifying at least one of the plurality of data structures to enforce one or more logical constraints of a plurality of logical constraints; wherein the one or more logical constraints remove, for one or more item instances of the plurality of item instances, candidate container instances of at least one container type from the set of candidate container instances of the one or more container types; wherein the plurality of logical constraints comprise a weight constraint, a volume constraint, and one or more other constraints;
repeating the assigning, the updating, and the modifying in one or more other iterations with one or more other item instances as the particular item instance of the plurality of item instances;
wherein, in at least one of the one or more other iterations, modifying at least one of the plurality of data structures to enforce one or more logical constraints of the plurality of logical constraints results in an assignment of a second item instance to a second candidate container instance of a second container type as an only non-empty remaining candidate container instance for the second item instance;
wherein, after the one or more other iterations, the plurality of item instances is assigned to a plurality of container instances of the one or more container types of the plurality of container types;
adjusting a container type of at least one of the plurality of container instances to reduce a cost of the plurality of container instances;
transmitting, to a consumer device, a blueprint comprising assignments of the plurality of item instances to the plurality of container instances.

17. The system of claim 16, wherein the set of actions further includes:
selecting the one or more logical constraints of the plurality of logical constraints as constraints that are potentially affected by assigning the particular item instance to the first candidate container instance;
evaluating the one or more selected logical constraints against any data structures that are potentially affected by assigning the particular item instance to the first candidate container instance; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations; and
updating another particular data structure of the plurality of data structures to indicate that a particular candidate container instance is not available for assignment to another particular item instance, corresponding to the other particular data structure, in the later iterations of assigning, updating, and modifying.

18. The system of claim 16, wherein the set of actions further includes:
selecting the one or more logical constraints of the plurality of logical constraints as constraints that are potentially affected by assigning the particular item instance to the first candidate container instance; wherein a particular selected logical constraint of the one or more selected logical constraints prevent item instances of the particular item type from being placed in a same container instance as other item instances of one or more other item types, wherein at least one of the one or more other item types is incompatible with the particular item instance;
evaluating the one or more selected logical constraints against any data structures that are potentially affected by assigning the particular item instance to the first candidate container instance; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations; and
updating another particular data structure of the plurality of data structures to indicate that the first candidate container instance is not available for assignment to another particular item instance, corresponding to the other particular data structure, in the later iterations of assigning, updating, and modifying, wherein the other particular item instance is selected for updating based on the other particular item instance matching at least one of the one or more other item types which are incompatible with the particular item instance.

19. The system of claim 16, wherein the set of actions further includes:
selecting the one or more logical constraints of the plurality of logical constraints as constraints that are potentially affected by assigning the particular item instance to the first candidate container instance; wherein a particular selected logical constraint of the one or more selected logical constraints prevents item instances of one or more groups of item types from being assigned to container instances beyond a threshold number of container instances;
evaluating the one or more selected logical constraints against any data structures that are potentially affected by assigning the particular item instance to the first candidate container instance; wherein the particular item type is in a particular group of the one or more groups of item types; and
updating a particular data structure of the plurality of data structures to indicate that candidate container instances other than the first candidate container instance and that other candidate container instances already holding item instances of the particular group are not available for assignment to the particular item instance, corresponding to the particular data structure, in later iterations of assigning, updating, and modifying; wherein the later iterations comprise the one or more other iterations; and
detecting that the threshold number of container instances has been reached for the particular group;
updating one or more other data structures corresponding to one or more other items having item types in the particular group to indicate that other container instances are not available for assignment to the one or more other items in the later iterations of assigning, updating, and modifying.

20. The system of claim 16, wherein the set of actions further includes:
selecting the one or more logical constraints of the plurality of logical constraints as constraints that are potentially affected by assigning the particular item instance to the first candidate container instance; wherein a particular selected logical constraint of the one or more selected logical constraints prevents item instances from being assigned to container instances that have already been assigned a threshold number of item instances;
evaluating the one or more selected logical constraints against any data structures that are potentially affected by assigning the particular item instance to the first candidate container instance; wherein the particular item type is in a particular group of one or more groups of item types; and
updating a particular data structure of the plurality of data structures to indicate that candidate container instances other than the first candidate container instance are not available for assignment to the particular item instance, corresponding to the particular data structure, in later iterations of assigning, updating, and modifying; wherein the later iterations comprise the one or more other iterations;
detecting that the threshold number of item instances in the first candidate container instance has been reached; and
updating one or more other data structures to indicate that the first candidate container instance is not available for assignment to one or more other particular item instances, corresponding to the one or more other data structures, in the later iterations of assigning, updating, and modifying.
